(19) United States
(12) Patent Application Publication
(10) Pub. No.: US 2020/0154946 A1
(43) Pub. Date: May 21, 2020

(54) TOASTER

(71) Applicant: Andrew J. Young, Batavia, NY (US)

(72) Inventor: Andrew J. Young, Batavia, NY (US)

(21) Appl. No.: 16/195,351

(22) Filed: Nov. 19, 2018

(51) Int. Cl. A47J 37/08

(52) U.S. Cl. CPC A47J 37/0821

(57) ABSTRACT

A toaster with a housing that includes a carriage for toasting bread that is propelled upward when released to eject the bread. The housing is mounted on legs that are shorter on one side than the other, so that ejected toast is propelled to fall on the shorter side onto a receiver or plate.

### BACKGROUND OF THE INVENTION

The invention is directed to a toaster that ejects bread completely from the toaster after toasting and transfers the toast to a receiver outside the toaster.

Toasters for toasting sliced bread are quite old. Such toasters raise the bread slices after toasting, such that about half of each slice remains in the toaster and half extends outside the toaster to provide a point of purchase for the user to grab hold of the slice and remove it from the toaster. A reoccurring problem with this is that the user wants to remove the bread slices soon after toasting either to make room for subsequent slices or wants to remove it while it is still hot in order to butter, or the like, and burns their fingers on the hot slices.

### SUMMARY OF THE INVENTION

A toaster is provided which has taller legs on one side thereof than on an opposite side. Furthermore, the carriage structure that holds one or more slices of bread within the toaster and that raises with the bread when the bread is toasted to the amount desired is mounted on a spring mechanism that provides sufficient kinetic energy or impotence to the bread after toasting is complete that it is fully ejected from the toaster. As the legs on one side of the toaster are longer than on the opposite side and the carriage holding the toast slices is also slanted with respect to vertical, the toasted slices are ejected to the shortened side of the toaster and fully clear the toaster so as to drop onto a plate or other selected receiver that is placed next to the toaster to receive the toasted slices. In this manner, the slices do not fall back into the toaster after being ejected.

### BRIEF DESCRIPTION OF THE DRAWINGS

FIG. 1 is a perspective view of a toaster in accordance with the present invention positioned beside a plate of toasted slices of bread.

FIG. 2 is a side elevational view of the taster shown ejecting toasted slices of bread shown in phantom and with the toast on the plate.

FIG. 3 is a side elevational view of the toaster.

FIG. 4 is a fragmentary perspective and partially schematic view of a control mechanism of the toaster with an end of the toaster removed to allow viewing of the control mechanism, taken along line 4-4 of FIG. 3.

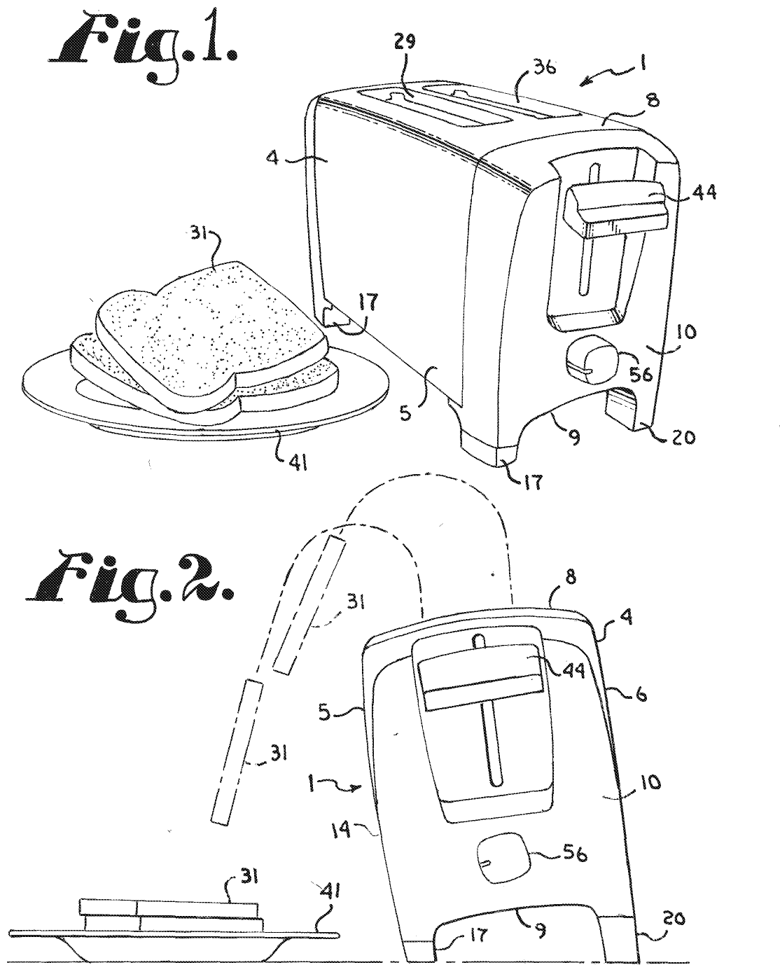

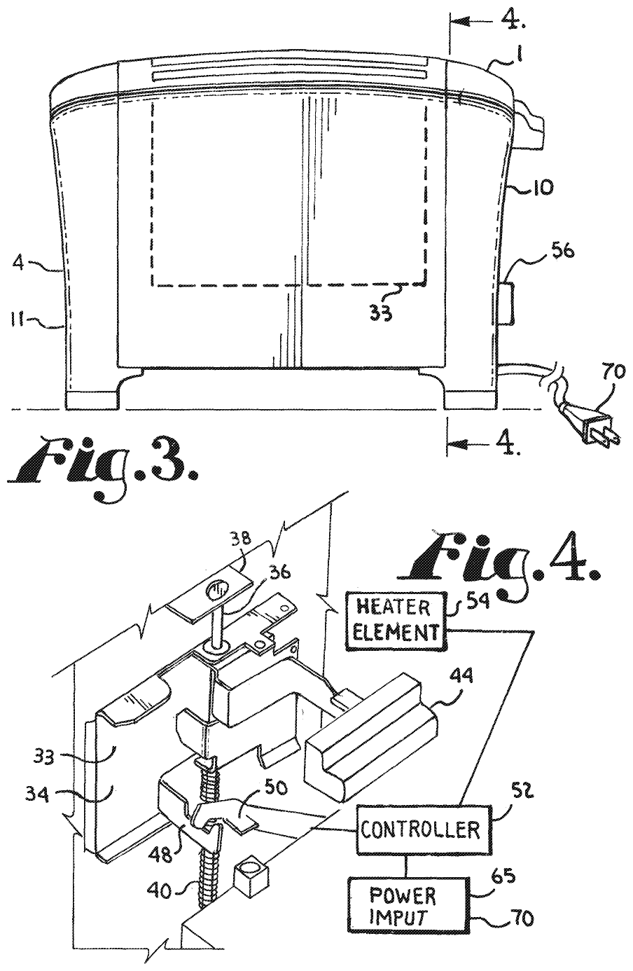

### OBJECTS OF THE INVENTION

It is an object of the invention to provide a toaster comprising a housing having opposed first and second sides, a top and a base; the base being higher on the first side thereof in comparison to the second side, such that the housing tilts to the second side; a slot located in the top with an opening beneath the slot, the opening being sized and shaped sufficiently large to receive a slice of bread; a carriage located in the opening also sized and shaped to receive a slice of bread; the carriage being moveable within the slot between a raised position and a lowered position; a releasable latch mechanism selectively holding the carriage in the lowered position; a spring mechanism continuously urging the carriage toward the raised position; the spring mechanism having sufficient force to eject the slice of bread from the toaster so as to fully clear the toaster and fall to the side of the toaster when the latch is released; a heater element located about the carriage when the carriage is in the lowered position to toast the slice of bread; and a power source providing electrical power to the heater element.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### DETAILED DESCRIPTION OF THE DISCLOSURE

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally indicates a toaster in accordance with the invention.

The toaster 1 includes a housing 4 having a first side 5 and an opposed second side 6. The toaster 1 further has a top 8 and a bottom base 9. The toaster 1 also has ends 10 and 11 which when joined with the sides 5 and 6, as well as the top 8 and base 9 form a rectangular shaped structure 14, similar in outward appearance to conventional toasters. However, the toaster 1 differs from conventional toasters in the support for the base 9 and, consequently, for the toaster as a whole.

In particular, the base 9 includes a first pair of legs 17 on the first side 5 that are substantially shorter than a second pair of legs 20. In the illustrated embodiment, the second pair of legs 20 is approximately twice as long as the first pair of legs 17, although other variances in length will work within the scope of the invention. Due to the difference in length between the pairs of legs 17 and 20, the base 9 and, consequently, the entire housing 4 is tilted with the sides 5 and 6 tilted preferably about 10° with respect to vertical, although tilting within the range of 5° to 20° or more with respect to vertical will function within the scope of the invention.

The housing top 8 includes at least one slot 29 and in the illustrated embodiment a second parallel slot 30 which slots are sized and shaped to slidingly receive a piece of bread 31 to be toasted.

Positioned within the housing 4 and beneath the slots 29 and 30 is a carriage 33 positioned so as to receive slices of bread 31 passing through the slots 29 and 30. The carriage 33 has an end plate 34, seen in FIG. 4, which is slideably mounted on a post 36 which in turn is mounted to the housing 4 at mounts 38.

Also, located on the post 36 is a compression spring 40. In the present embodiment, 3 separate springs are mounted one on top of the other to form the overall spring 40. The spring 40 provides sufficient energy that after being compressed and then released, the spring 40 provides enough upward and outward force to the bread slices 31 through the carriage 33 so that the slices 31 are entirely ejected from the toaster 1, as is illustrated in FIG. 2 in phantom and then fall to land and be supported on a receiver, here a plate 41.

The carriage 33 includes a handle 44 utilized to manually depress the carriage 33 and in doing so to compress the spring 40 by a user. When the carriage 33 is depressed sufficiently to hold the bread slices 31 entirely within the toaster 1, a latch shelf 48 that extends from the carriage 33 is captured by a releaseable latch mechanism 50. The latch mechanism 50 is in turn controlled by a controller 52. The controller 52 can be that associated with any conventional toaster and many different controllers have been illustrated in patents and used in various prior toasters, such as U.S. Pat. No. 9,131,804, which is incorporated herein by reference. The controller is also joined to a heater element 54, as also is found in many prior art toasters. Depressing the carriage 33 initiates heating by the heating element 54. The controller 52 is joined to a control knob 56 that allows a user to choose a time or doneness for toasting the slices 31. When the controller 52 times out or the toast s done, it sends a signal to discontinue toasting to the heating element 54 and to release the latch mechanism 50 which in turn releases the spring 40 to exert upward force on the carriage 33 and expel the slices 31 from the toaster 1, as shown in phantom in FIG. 2. By joining with the carriage 33 through various linkage, the controller 54 determines the length of time the bread 31 is toasted and the release of the bread slices 31.

It is noted that the carriage 33 is slanted at the same angle as the housing 4, which causes the slices to eject to the left or shorter leg 17 side 5 in FIG. 2.

A power cable 70 provides electrical power to the controller 52 and the toaster 1, in general.

It is foreseen that the springs 40 could be replaced effectively by other means of storing and releasing kinetic energy, such as a compressed gas or air system which could be utilized to eject the slices 31.

It is to be understood that while certain forms of the present invention have been illustrated and described herein, it is not to be limited to the specific forms or arrangement of parts described and shown.

Having thus described the invention what is claimed as new and desired to be secured by Letters Patent is as follows:

1. A toaster comprising:
a) a housing having opposed first and second sides, a top and a base; the base being higher on the first side thereof in comparison to the second side, such that the housing tilts to the second side;
b) a slot located in the top with an opening beneath the slot, the opening being sized and shaped sufficiently large to receive a slice of bread;
c) a carriage located in the opening also sized and shaped to receive a slice of bread; the carriage being moveable within the slot between a raised position and a lowered position;
d) a releasable latch mechanism selectively holding the carriage in the lowered position;
e) a spring mechanism continuously urging the carriage toward the raised position; the spring mechanism having sufficient force to eject the slice of bread from the toaster so as to fully clear the toaster and fall to the side of the toaster when the latch is released;
f) a heater element located about the carriage when the carriage is in the lowered position to toast the slice of bread; and
g) a power source providing electrical power to the heater element.

2. The toaster according to claim 1 wherein the housing further includes:
a) a handle to manually push the carriage from the raised position to the lowered position;
b) a timer to selectively choose the time during which the slice is toasted and at the end of the chosen time releases the latch; and
c) linkage between the timer and the latch to allow the timer to release the latch.

3. The toaster according to claim 1 wherein:
a) the carriage slides on an elongate circular guide post; and
b) the spring mechanism is a circular spring mounted on the guide post.

4. The toaster according to claim 1 wherein:
a) the carriage has parallel sides; and
b) the body is sufficiently tilted such that the carriage sides are at an angle of at least 10° with respect to vertical.

5. The toaster according to claim 4 wherein the angle is 15°.

6. The toaster according to claim 1 wherein the base is mounted on legs that are longer on the first side than on the second side.
